(19) United States
(12) Patent Application Publication
(10) Pub. No.: US 2008/0134011 A1
(43) Pub. Date: Jun. 5, 2008

(54) IMAGE FORMING APPARATUS

(75) Inventor: Yoshihiro OGURA, Kanagawa (JP)

Correspondence Address: COOPER & DUNHAM, LLP, 1185 AVENUE OF THE AMERICAS, NEW YORK, NY, 10036, US

(73) Assignee: Ricoh Company, Ltd., Tokyo (JP)

(21) Appl. No.: 11/942,332

(22) Filed: Nov. 19, 2007

(30) Foreign Application Priority Data
Dec. 1, 2006 (JP) 2006-325689

(51) Int. Cl. G06F 17/00

(52) U.S. Cl. 715/200

(57) ABSTRACT

A disclosed image forming apparatus enables a report or list to be printed out in a manner optimized for each user. The image forming apparatus includes a user authentication unit for user authentication. A print mode for a report or list is registered for each user of the apparatus. Upon authentication of a user with the authentication unit, the print mode registered for the user is retrieved from memory and used when printing the report or list for the user. The print mode may comprise, e.g., an image magnification ratio relative to a standard print size; a modification of characters used for the printing of an item for each user; or a modification of characters used for the printing of a report, such as a facsimile transmission report, for each user when the report contains particular content.

### BACKGROUND OF THE INVENTION

1. Field of the Invention

The present invention relates to an image forming apparatus having a user authentication unit for authenticating a user, and to a method of customizing a printed output of such an image forming apparatus.

2. Description of the Related Art

More and more people are paying increasing attention to the concept of accessibility as it indicates the degree to which services, systems, software and the like are usable by as wide a variety of people as possible, particularly by the elderly and people with disabilities.

Japanese Laid-Open Patent Application No. 2003-335033 discloses that a switch is provided that enables the selection of a person-with-no-disabilities mode and a person-with-disabilities mode. The latter includes a total blind mode, amblyopic mode, colorblind mode, hearing-impaired mode, slow movement mode, and wheelchair mode, which are placed in memory. Based on a selected mode, the operating panel display is customized for a particular user.

In such related art, which is directed to image forming apparatuses including multifunction (e.g., copy, fax, scan, and print) peripheral systems, personal authentication may be performed based on a personal identification number, fingerprint, or the like. Based on the result of authentication, a person-with-disabilities mode, such as the amblyopic mode or colorblind mode, is set when the person-with-disabilities mode is selected. In accordance with the thus selected mode, the brightness of a display screen and the size/color of characters displayed on it, for example, are modified. However, no automatic modification or customization has been made in printed outputs, such as in the form of a report or list, in accordance with personal authentication settings. As a result, there is room for improvement in terms of the ease with which an individual user can view such printed outputs, i.e., a report or list.

### SUMMARY OF THE INVENTION

It is a general object of the present invention to provide an image forming apparatus and a method in which the aforementioned problems are eliminated.

A more specific object of the invention is to provide an image forming apparatus capable of producing a printed output in a print mode, such as a format and a layout, based on settings entered by individual users for optimum ease of understanding.

In one aspect, the invention provides an image forming apparatus comprising a user authentication unit configured to authenticate a user; a registration unit configured to register a print mode in association with each user of the image forming apparatus; a printer unit; and a control unit. Upon authentication of a user with the authentication unit, the control unit causes the printer unit to print information regarding an operation of the image forming apparatus in a registered print mode associated with the user.

In an embodiment, the print mode comprises a ratio of magnification of the information relative to a standard print size.

In another embodiment, the print mode comprises a modification of characters used for the printing of the information.

In another embodiment, the registered print mode associated with the user is used when the information regarding an operation contains particular content.

In yet another embodiment, the information regarding an operation of the image forming apparatus comprises a facsimile report.

In another aspect, the invention provides a method of customizing a printed output of an image forming apparatus having a user authentication unit, the method comprising the steps of registering a print mode in association with each user of the image forming apparatus; authenticating a user with the user authentication unit; and printing information regarding an operation of the image forming apparatus for the authenticated user in a print mode registered in association with the user.

In another aspect, the invention also provides a computer-readable program for causing a computer to perform the above method.

Other objects, features, and advantages of the present invention will become apparent from the following description when taken in conjunction with the accompanying drawings.

### BRIEF DESCRIPTION OF THE DRAWINGS

FIG. 1 shows a block diagram of a network-ready multifunction peripheral apparatus according to an embodiment of the invention;

FIG. 2A shows user-set information in the embodiment;

FIG. 2B shows the details of basic information contained in the user-set information in the embodiment;

FIG. 2C shows the details of layout information contained in the user-set information in the embodiment;

FIG. 2D shows the details of format information contained in the user-set information in the embodiment;

FIG. 2E shows the details of a detailed information in communication management report portion of the user-set information in the embodiment;

FIG. 2F shows communication log information in accordance with the embodiment;

FIG. 3 shows an example of a communication management report;

FIG. 4 shows another example of a communication management report;

FIG. 5 shows a flowchart of a process of printing a report or list based on a manual operation of the network-ready multifunction peripheral apparatus by a user; and

FIG. 6 shows a flowchart of a process of automatically printing a report or list following the transmission of an image by a user.

### DETAILED DESCRIPTION OF THE PREFERRED EMBODIMENT

In the following, the invention is described by way of a preferred embodiment thereof with reference to the drawings.

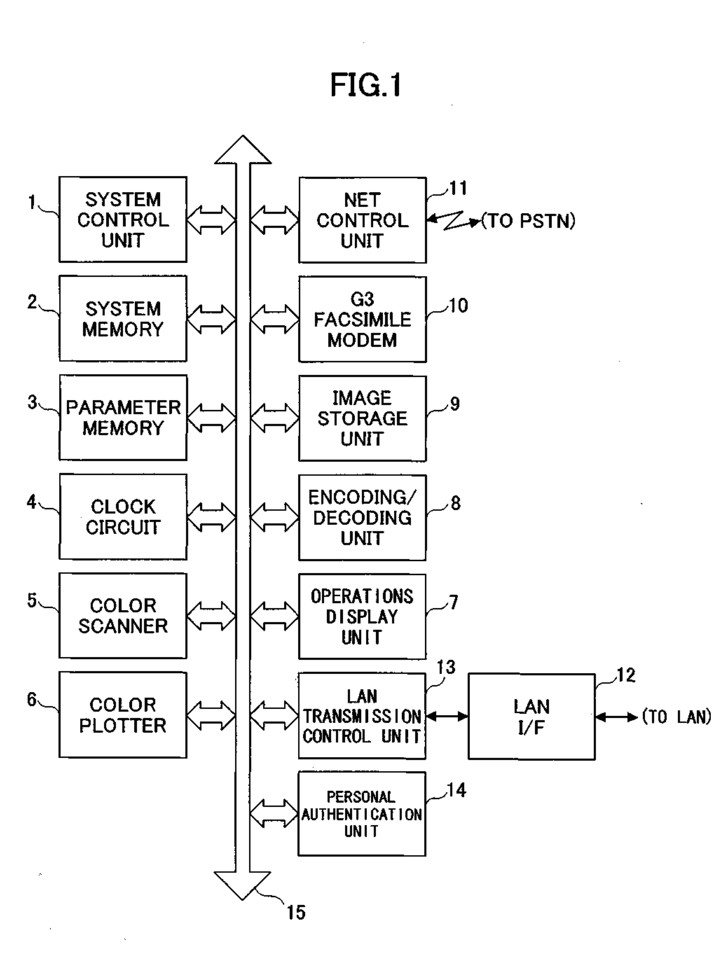

FIG. 1 shows a block diagram of a network-ready multifunction peripheral apparatus according to an embodiment of the invention. The network-ready multifunction peripheral apparatus includes a personal authentication function for authenticating a user; a network communication function for connecting the apparatus to a local area network to perform communications via electronic mail or other means based on any of a variety of protocols; a facsimile communication function for connecting the apparatus to a public network to perform Group 3 facsimile communications; a color copy function for copying a color manuscript; and a scanner function for reading a color manuscript image.

As shown in the figure, a system control unit 1 controls the individual units of the network-ready multifunction peripheral apparatus for color copying, communication application control, and facsimile transmission control procedures, for example. A system memory 2 is used to save a control processing program executed by the system control unit 1, and various items of data necessary for the execution of the processing program. The system memory 2 also provides a work area for the system control unit 1. A parameter memory 3 is used to save various kinds of information inherently associated with the network-ready multifunction peripheral apparatus. A clock circuit 4 outputs the current time information.

A color scanner 5 is configured to read a color manuscript image with a predetermined resolution. A color plotter 6 is configured to output a color image with a predetermined resolution. An operations display unit 7 includes various operation keys and indicators for operating the network-ready multifunction peripheral apparatus.

An encoding/decoding unit 8 is configured to encode or compress color image data and to decode encoded or compressed image information back to its original color image data. An image storage unit 9 is used to save a number of items of image information in encoded or compressed form.

A Group 3 facsimile modem 10, which provides a Group 3 facsimile modem function, includes a low-speed modem function (V.21 modem) for the exchange of transmission procedure signals, and a high-speed modem function (such as, e.g., V.17 modem, V.34 modem, V.29 modem, or V.27 ter modem) mainly for the exchange of image information.

A net control unit 11 is configured to connect the network-ready multifunction peripheral apparatus to an analog PSTN (public switched telephone network). The net control unit 11 has an automatic call send/receive function.

A local area network interface circuit 12 is configured to connect the network-ready multifunction peripheral apparatus to a local area network. A local area network transmission control unit 13 is configured to perform communication control processing according to any of a variety of predetermined protocol suites for the exchange of various data with other data terminal devices via the local area network.

A personal authentication unit 14 is configured to authenticate a user using any of a variety of methods, such as, e.g., one based on a personal identification number or biometric authentication, such as fingerprint authentication. Biometric authentication, which is based on the physical characteristics of a user, refers to an authentication technique based on individual unique features enabling identification of each person.

The system control unit 1, system memory 2, parameter memory 3, clock circuit 4, scanner 5, plotter 6, operations display unit 7, encoding/decoding unit 8, image storage unit 9, Group 3 facsimile modem 10, net control unit 11, local area network transmission control unit 13, and personal authentication unit 14 are all connected to an internal bus 15 via which data exchange between the individual elements mainly occurs.

The exchange of data between the net control unit 11 and the Group 3 facsimile modem 10 is carried out directly.

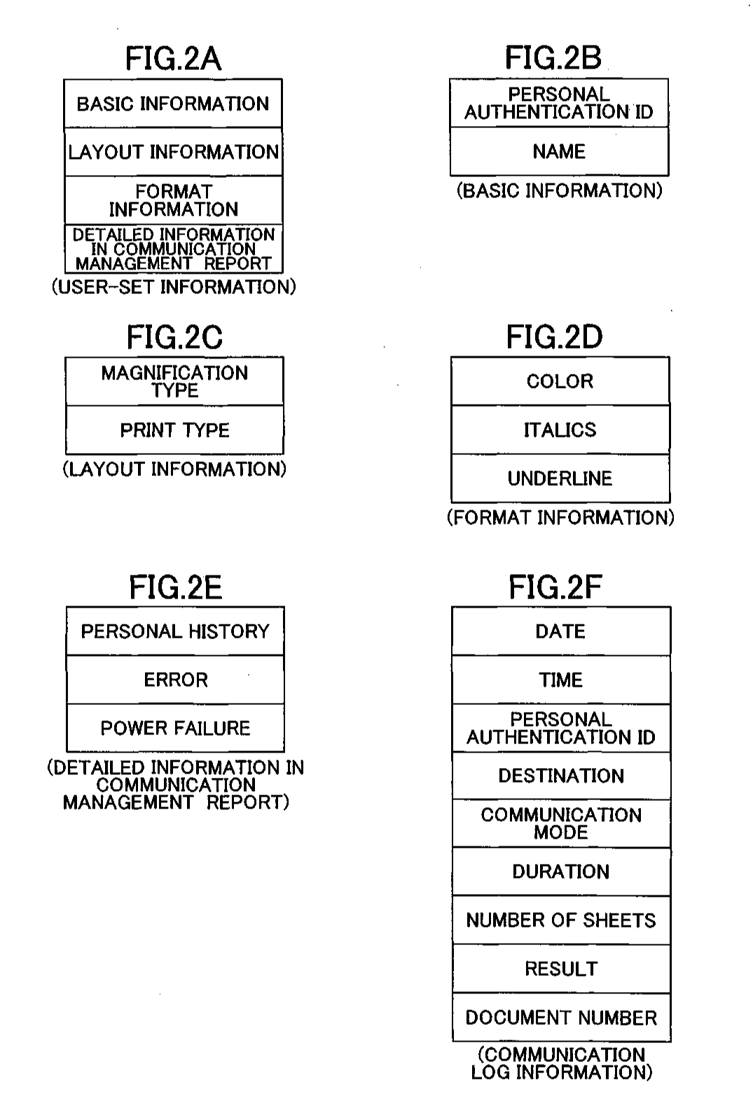

In order to manage individual users, the network-ready multifunction peripheral apparatus is configured to save user-set information as shown in FIG. 2A. The user-set information is created for each user and saved in the parameter memory 3, for example.

User-set information consists of, e.g., “Basic information”; “Layout information” pertaining to a layout for the printing of a report or list; “Format information”; and “Detailed information in communication management report.” The basic information consists of a personal authentication ID (such as “XXX001” or “XXX02”) identifying each user, and a name (such as a family name, given name, or nickname), for example, as shown in FIG. 2B.

As shown in FIG. 2C, the layout information consists of a “Magnification type” indicating a magnification ratio (such as “100%” or “120%”) for the printing of a report or list, and a “Print type” pertaining to page-related setting information for printing (such as, e.g., “Print on multiple pages,” “Normal printing,” and “Print on optimized sheet”). Thus, the layout information includes items concerning a printed page that can be set via a setting screen on a printer driver, for example.

The format information includes, as shown in FIG. 2D, “Color” (such as “Black,” “Red,” or “Blue”) indicating the color of a printed character; “Italics” indicating whether a character should be printed in italics; and “Underline” indicating whether a printed character should be underlined. The italics setting is represented by a value indicating either “Reflect” (i.e., italics should be used), or “Do not reflect” (i.e., italics should not be used). The underline setting is represented by a value indicating either “Reflect” (i.e., the character should be underlined) or “Do not reflect” (i.e., the character should not be underlined). Information including layout information and format information is also referred to as print mode information.

The detailed information in the communication management report includes, as shown in FIG. 2E, “Personal history” indicating whether the customized format information should be reflected with regard to all of the items (e.g., transmissions and receptions) in the communication history of a particular user in a communication management report; “Error” indicating whether the customized format information should be reflected with regard to a failed item in a communication management report; and “Power failure” indicating whether the customized format information should be reflected with regard to an item in the communication management report with respect to which power failure has occurred. These settings, i.e., the personal history, error, and power failure settings, are represented by values indicating either “Reflect” (i.e., the customized format information should be reflected for the relevant printed item) or “Do not reflect” (i.e., the customized format information should not be reflected; a standard format should be used).

In the network-ready multifunction peripheral apparatus, upon transmission or reception of a facsimile or electronic mail, communication log information is created for each transmission or reception operation as shown in FIG. 2F and saved in the system memory 2 or the parameter memory 3, for example.

As shown in FIG. 2F, the communication log information includes “Date” indicating the date of communication; “Time” indicating the time of communication; “Personal authentication ID” for user authentication; “Address” indicating the ID information of a party at the other end of communication; “Mode” indicating the operation mode of communication; “Duration” indicating the duration of time spent for communication; “Pages” indicating the number of manuscripts communicated; “Result” indicating a communication result; and “File” indicating a document file number communicated.

In the case of a facsimile communication, the print mode is represented by values indicating whether the communication involves a transmission, a reception, or a memory transmission, and the scanning line density (fine/standard). In the case of electronic mail, the print mode is represented by a value indicating whether the communication involves a transmission or a reception, for example.

The values in the “Result” section include “OK” indicating normal conclusion; “Error 1,” “Error 2,” “Error 3,” “Error 4,” and “Error 5” indicating the presence of a communication error and its type; and “Power failure” indicating a communication error due to power failure. With regard to the various errors, “Error 1” indicates an interruption; “Error 2” indicates the line is busy; “Error 3” indicates there is no response; “Error 4”, indicates a wrong address; and “Error 5” indicates an excess mail size, for example.

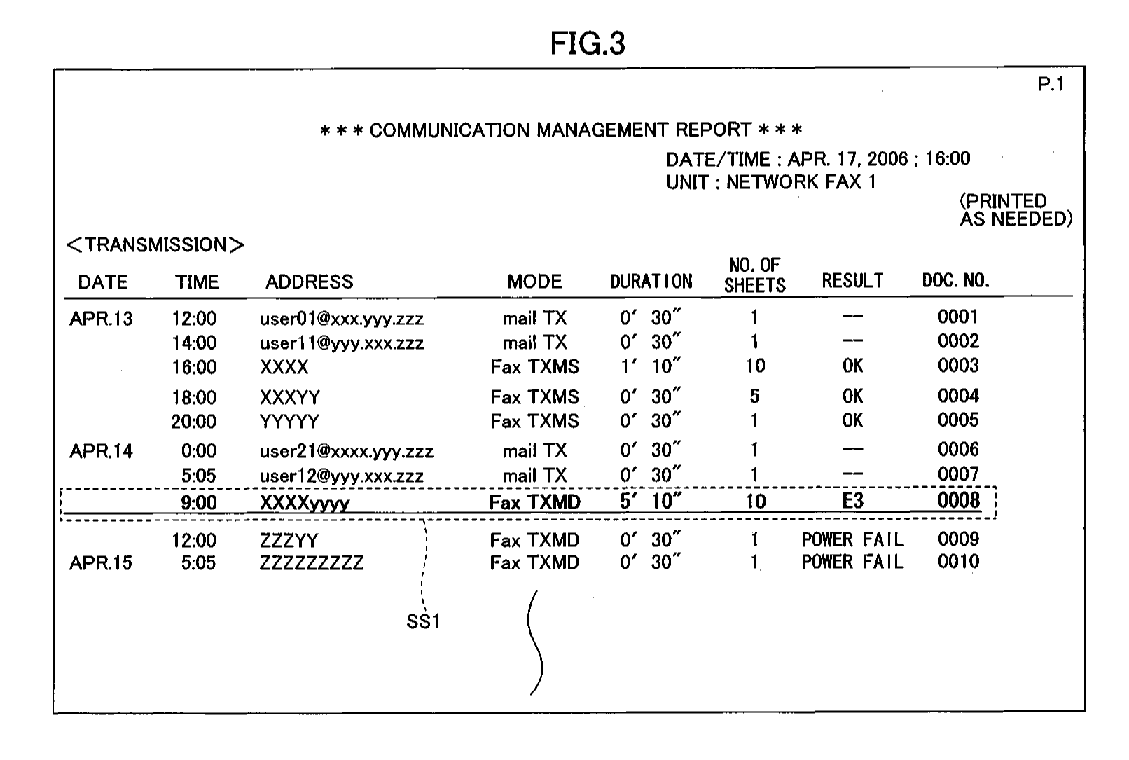

FIG. 3 shows an example of the communication management report, which is created and output based on the aforementioned communication log information. In this example, the value in “Error result” in the “Detailed information in communication management report” section of the user-set information is “Reflect.” In the format information, the value in “Color” is “Red”; the value in “Underline” is “Reflect”; and the value in “Italics” is “Do not reflect.” Thus, the relevant printed portion appears as enclosed by a broken line SS1.

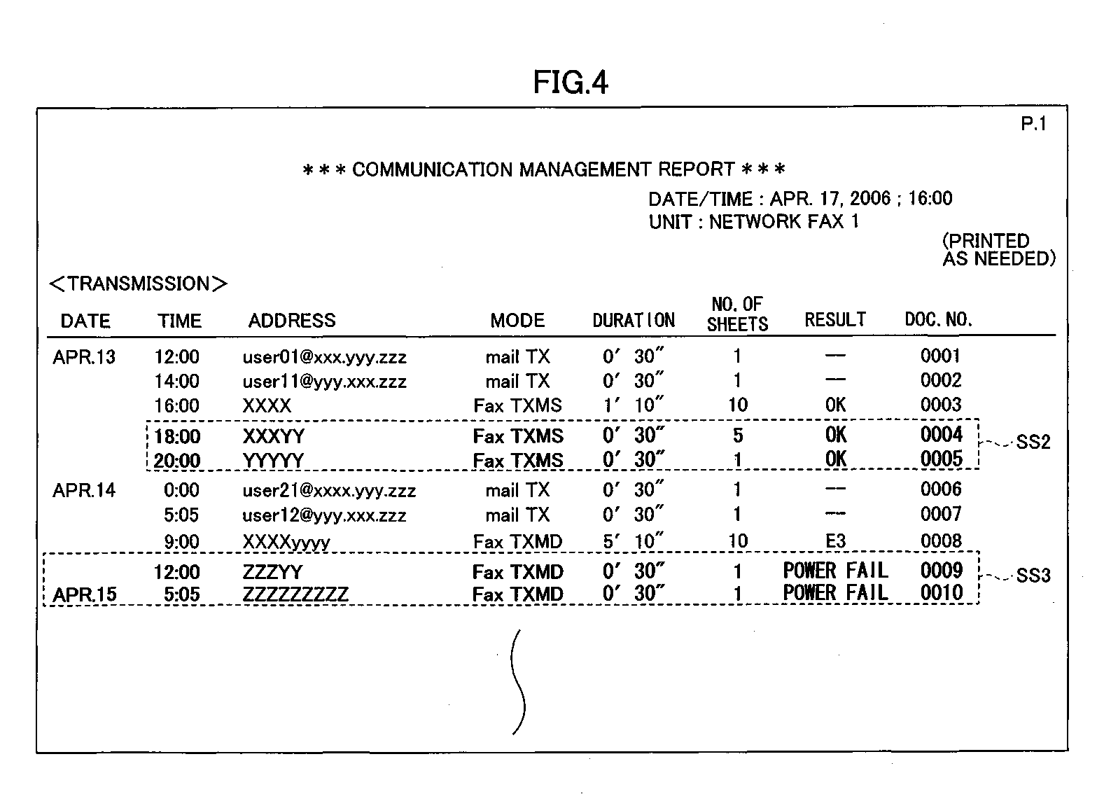

FIG. 4 shows another example of the communication management report. In this case, the value in “Individual history” in the “Detailed information in communication management report” section of the user-set information is “Reflect.” In the format information, the value in “Color” is “Blue”; the value in “Italics” is “Reflect”; and the value in “Underline” is “Do not reflect.” The portions enclosed by broken lines SS2 and SS3 are the relevant printed portions.

While FIGS. 3 and 4 only show transmission parts, reception parts may also continue underneath.

FIG. 5 shows a flowchart of a user-initiated process of printing a report or list based on a manual operation of the network-ready multifunction peripheral apparatus. In this case, the user, after a successful personal authentication, selects a report or list the desires to print.

Upon successful personal authentication of the user, his personal authentication ID is acquired as user ID information. Based on the acquired personal authentication ID, the stored user-set information is searched for the user-set information associated with the authenticated user (step 101).

Then, in accordance with the acquired user-set information, a particular item is modified by, e.g., changing its format or enlarging its image (step 102).

Further, in accordance with the acquired user-set information, an optimum sheet is selected for the report or list containing the modified image, and a printed output is produced (step 103).

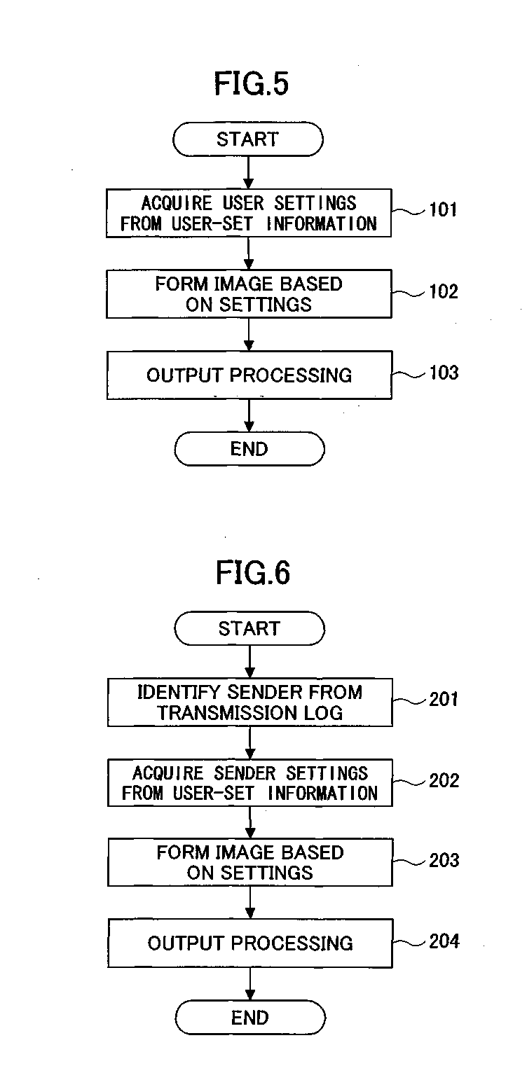

FIG. 6 shows a flowchart of an automated process of printing a report or list after an image is transmitted. An automatic output may be triggered by an unsuccessful transmission of an image due to some failure, for example. Alternatively, an output setting may be made such that a report or list is output regardless of the result of transmission.

First, the sender of the image that has triggered automatic output of a report or list is identified by searching the communication log information (step 201).

Then, based on the sender's personal authentication ID, the stored user-set information is searched for the sender's user-set information (step 202).

In accordance with the acquired user-set information, a particular item is modified by, e.g., changing its format or enlarging its size (step 203).

Further, in accordance with the acquired user-set information, an optimum sheet is selected for the report or list containing the modified image, and a printed output is produced (step 204).

Thus, in accordance with the present embodiment, a report or list is automatically modified (customized) and then printed in accordance with the settings of the user identified by the personal authentication unit 14, so that the operational burden can be reduced, and an enhanced level of understanding can be achieved.

Since the layout of the report or list can be automatically adapted to multiple pages based on a user setting, the problem of a report or list inadvertently extending over more than one page when printed and thus making the report or list difficult to see can be eliminated. Thus, operational burden can be reduced and a report or list can be printed in a manner optimized for each user, thereby facilitating understanding of the data in the printed image.

Since an optimum print sheet can be automatically selected in accordance with a user setting, the problem of the report or list inadvertently extending over more than one page and thus making the report or list difficult to see can be eliminated. In this way, the operational burden can be reduced and a report or list can be printed in a manner optimized for each user, thereby enhancing the level of understanding.

Since the format for a particular item in a report or list can be automatically changed in accordance with the settings of the user identified by the personal authentication unit, the operational burden can be reduced and the report or list can be printed in a manner optimized for each user. Thus, an enhanced level of understanding can be achieved.

Since the format for printing a transmission history (transmissions and/or receptions) of an authenticated user can be automatically changed, visual understanding of the transmission history of the authenticated user can be facilitated and an enhanced level of understanding can be achieved.

Furthermore, since format settings can be customized for each user as he considers optimum, an enhanced level of understanding can be achieved.

In the case of an automatic output of a report or list after the transmission of an image, even if the user, after using the image forming apparatus, has moved away from the apparatus, the user can be identified and his report or list can be modified in accordance with the user's user-set information. Thus, the operational burden can be reduced and a report or list can be printed in a manner optimized for each user, thereby achieving an enhanced level of understanding.

While the foregoing embodiment involves a network-ready multifunction peripheral apparatus, the present invention can be applied to other types of image forming apparatuses equipped with a communication function.

Although the invention has been shown and described with reference to a preferred embodiment, it should be obvious that equivalents and modifications may occur to one skilled in the art without departing from the spirit and scope of the invention as defined by the appended claims.

The present application is based on the Japanese Priority Application No. 2006-325689 filed Dec. 1, 2006, the entire contents of which are hereby incorporated by reference.

What is claimed is:

1. An image forming apparatus comprising:
a user authentication unit configured to authenticate a user;
a registration unit configured to register a print mode in association with each user of the image forming apparatus;
a printer unit; and
a control unit;
wherein, upon authentication of a user with the authentication unit, the control unit causes the printer unit to print information regarding an operation of the image forming apparatus in a registered print mode associated with the user.

2. The image forming apparatus according to claim 1, wherein the print mode comprises a ratio of magnification of the information relative to a standard print size.

3. The image forming apparatus according to claim 1, wherein the print mode comprises a modification of characters used for the printing of the information.

4. The image forming apparatus according to claim 1, wherein the registered print mode associated with the user is used when the information regarding an operation contains particular content.

5. The image forming apparatus according to claim 1, wherein the information regarding an operation of the image forming apparatus comprises a facsimile report.

6. A method of customizing a printed output of an image forming apparatus having a user authentication unit, the method comprising the steps of:
registering a print mode in association with each user of the image forming apparatus;
authenticating a user with the user authentication unit; and
printing information regarding an operation of the image forming apparatus for the authenticated user in a print mode registered in association with the user.

7. The method according to claim 6, wherein the print mode comprises a ratio of magnification of the information relative to a standard print size.

8. The image forming method according to claim 6, wherein the print mode comprises a modification of characters used for the printing of the information.

9. A computer-readable program for causing a computer to perform a method for customizing a printed output of an image forming apparatus having a user authentication unit, the method comprising the steps of:
registering a print mode in association with each user of the image forming apparatus;
authenticating a user with the user authentication unit; and
printing information regarding an operation of the image forming apparatus for the authenticated user in a print mode registered in association with the user.
